(19) United States
(12) Patent Application Publication
(10) Pub. No.: US 2023/0239761 A1
(43) Pub. Date: Jul. 27, 2023

(54) METHODS, DEVICES, AND MEDIUM FOR COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 17/919,050

(22) PCT Filed: Apr. 17, 2020
(86) PCT No.: PCT/CN2020/085404

§ 371 Date: Oct. 14, 2022

(51) Int. Cl. H04W 36/30; H04W 36/00

(52) U.S. Cl. CPC H04W 36/304; H04W 36/0088

(57) ABSTRACT

Embodiments of the present disclosure relate to communication. According to embodiments of the present disclosure, new power thresholds are introduced for triggering and/or quitting the relaxed measurement mode. In this way, the terminal device can be avoided entering into the relaxed measurement mode if the terminal device is at the cell edge. Further, a network device configured mapping information of neighbor cells for entering the relaxed measurement mode. In this way, the related measurement mode can be selected for a proper neighboring cell. Moreover, a terminal device may be configured with one or more identities for descrambling downlink information. In this way, resources at the terminal device can be saved.

### TECHNICAL FIELD

Embodiments of the present disclosure generally relate to the field of telecommunication, and in particular, to methods, devices, and medium for communication.

### BACKGROUND

Communication technologies have been developed rapidly. In cellular networks, when a terminal device moves from cell to cell and performs cell selection/reselection and handover, it has to measure the signal strength/quality of the neighbor cells. For example, in long term evolution (LTE) network, a terminal device may measure two parameters on reference signal: RSRP (Reference Signal Received Power) and RSRQ (Reference Signal Received Quality). Moreover, a relaxed measurement has been introduced to save battery power at the terminal device. Further study on the relaxed measurement is needed to enhance the relaxed measurement.

### SUMMARY

In general, example embodiments of the present disclosure provide a solution of a relaxation measurement enhancement.

In a first aspect, there is provided a method for communication. The method comprises determining, at a terminal device, a receiving power and a signal quality of a signal transmitted on a serving cell from a network device. The method further comprises determining whether the receiving power exceeds a threshold power and the signal quality exceeds a threshold quality. The method also comprises in accordance with a determination that the receiving power exceeds the threshold power and the signal quality exceeds the threshold quality, entering a relaxed measurement mode with less number of measurements on the serving cell than a normal measurement mode.

In a second aspect, there is provided a method for communication. The method comprises receiving, at a terminal device, mapping information transmitted on a serving cell from a network device, the mapping information at least indicating a relationship between a first frequency band allocated for a first neighbor cell of the serving cell and a first threshold power for triggering a reduced measurement mode on the first neighbor cell, the reduced measurement mode with reduced number of measurements than a normal measurement mode. The method also comprises determining a first receiving power of a first signal transmitted at the first frequency band. The method further comprises entering the reduced measurement mode on the first neighbor cell based on the receiving power and the mapping information.

In a third aspect, there is provided a method for communication. The method comprises receiving, at a terminal device and from a network device, configuration information indicating one or more activated identity indices for paging. The method further comprises receiving control information from the network device. The method also comprises processing the control information based on the one or more activated identity indices.

In a fourth aspect, there is provided a method for communication. The method comprises determining, at a network device in a serving cell, mapping information at least indicating a relationship between a first frequency band allocated for a first neighbor cell of the serving cell and a first threshold power for triggering a reduced measurement mode on the first neighbor cell, the reduced measurement mode with reduced number of measurements than a normal measurement mode. The method further comprises transmitting the mapping information to at a terminal device in the serving cell.

In a fifth aspect, there is provided a method for communication. The method comprises transmitting, at a network device, configuration information to a terminal device, the configuration information indicating one or more activated identity indices for paging. The method further comprises generating control information based on the one or more activated identity indices. The method also comprises transmitting the control information to the network device.

In a sixth aspect, there is provided a terminal device. The terminal device comprises a processing unit; and a memory coupled to the processing unit and storing instructions thereon, the instructions, when executed by the processing unit, causing the terminal device to perform acts comprising: determining, at a terminal device, a receiving power and a signal quality of a signal transmitted on a serving cell from a network device; determining whether the receiving power exceeds a threshold power and the signal quality exceeds a threshold quality; and in accordance with a determination that the receiving power exceeds the threshold power and the signal quality exceeds the threshold quality, entering a relaxed measurement mode with less number of measurements on the serving cell than a normal measurement mode.

In a seventh aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device, mapping information transmitted on a serving cell from a network device, the mapping information at least indicating a relationship between a first frequency band allocated for a first neighbor cell of the serving cell and a first threshold power for triggering a reduced measurement mode on the first neighbor cell, the reduced measurement mode with reduced number of measurements than a normal measurement mode; determining a first receiving power of a first signal transmitted at the first frequency band; and entering the reduced measurement mode on the first neighbor cell based on the receiving power and the mapping information.

In an eighth aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device and from a network device, configuration information indicating one or more activated identity indices for paging; receiving control information from the network device; and processing the control information based on the one or more activated identity indices.

In a ninth aspect, there is provided a network device. The network device comprises a processing unit; and a memory coupled to the processing unit and storing instructions thereon, the instructions, when executed by the processing unit, causing the network device to perform acts comprising: determining, at a network device in a serving cell, mapping information at least indicating a relationship between a first frequency band allocated for a first neighbor cell of the serving cell and a first threshold power for triggering a reduced measurement mode on the first neighbor cell, the reduced measurement mode with reduced number of measurements than a normal measurement mode; and transmitting the mapping information to at a terminal device in the serving cell.

In a tenth aspect, there is provided a network device. The network device comprises a processing unit; and a memory coupled to the processing unit and storing instructions thereon, the instructions, when executed by the processing unit, causing the network device to perform acts comprising: transmitting, at a network device, configuration information to a terminal device, the configuration information indicating one or more activated identity indices for paging; generating control information based on the one or more activated identity indices; and transmitting the control information to the network device.

In an eleventh aspect, there is provided a computer readable medium having instructions stored thereon, the instructions, when executed on at least one processor, causing the at least one processor to carry out the method according to any one of the first aspect, second aspect, third aspect, fourth aspect, or fifth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment;

FIG. 2 is a schematic diagram of a communication environment in which embodiments of the present disclosure can be implemented;

FIG. 3 is a flowchart of an example method in accordance with an embodiment of the present disclosure;

FIG. 4 illustrates a schematic diagram of measurement timings in accordance with an embodiment of the present disclosure;

FIG. 5 is a flowchart of an example method in accordance with an embodiment of the present disclosure;

FIG. 6 is a flowchart of an example method in accordance with an embodiment of the present disclosure;

FIG. 7 is a flowchart of an example method in accordance with an embodiment of the present disclosure;

FIG. 8 is a flowchart of an example method in accordance with an embodiment of the present disclosure;

FIG. 9 illustrates a signaling flow for relaxed measurements according to some embodiments of the present disclosure;

FIG. 10 illustrates a signaling flow for paging according to some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, in LTE, the relaxed measurement has been introduced to save battery power at the terminal device. In new radio (NR) systems, some enhancement on the relaxed measurement has been introduced. In the relaxed measurement, if a reference received power value of the serving cell (S_{rxlevRef}) will be updated to current received power value of the serving cell (Sᵣₓₗₑᵥ) value, then Sᵣₓₗₑᵥ value is larger than S_{rxlevRef}. But by far there is no mechanism to reduce the value of S_{rxlevRef}.

Further, according to conventional technologies, it is agreed to enhance paging mechanisms to minimize the terminal device from monitoring paging occasions (POs). When the terminal device is required to perform intra-frequency or inter-frequency measurements according to the measurement rules, the terminal device may choose not to perform intra-frequency or inter-frequency measurements when (1) the relaxed monitoring criterion in sub-clause 5.2.4.12.1 is fulfilled for a period of T_{SearchDeltaP}; (2) less than 24 hours have passed since measurements for cell reselection were last performed, (3) the terminal device has performed intra-frequency or inter-frequency measurements for at least T_{SearchDeltaP} after selecting or reselecting a new cell.

According to conventional technologies, the relaxed monitoring criterion is fulfilled as formula 1 below:

S_{rxlevRef}−Sᵣₓₗₑᵥ<SSearchDeltaP (1)

where Sᵣₓₗₑᵥ presents current Sᵣₓₗₑᵥ value of the serving cell (dB), S_{rxlevRef} represents reference Sᵣₓₗₑᵥ value of the serving cell (dB).

The terminal device shall set the value of S_{rxlevRef} to the current Sᵣₓₗₑᵥ value of the serving cell if one of the followings is satisfied: (1) after selecting or reselecting a new cell; (2) if (Sᵣₓₗₑᵥ−S_{rxlevRef})>0; or (3) if the relaxed monitoring criterion has not been met for T_{SearchDeltaP}. In some embodiments, T_{SearchDeltaP} may be 5 minutes, or the eDRX cycle length if eDRX is configured and the eDRX cycle length is longer than 5 minutes.

Further, upon reception of a paging message, when the terminal device is in radio resource control (RRC)_IDLE, for each of paging records, if the ue-Identity included in the paging records matches the terminal device identity allocated by upper layers, the terminal device may forward the ue-Identity and access Type (if present) to the upper layers. When the terminal device is in RRC INACTIVE, for each of paging records, if the ue-Identity included in the PagingRecord matches the terminal device's stored fullI-RNTI and if the terminal device is configured by upper layers with Access Identity 1, the terminal device may initiate the RRC connection resumption procedure. If the terminal device is configured by upper layers with Access Identity 2, the terminal device may initiate the RRC connection resumption procedure. If the terminal device is configured by upper layers with one or more Access Identities equal to 11-15, the terminal device may initiate the RRC connection resumption procedure. Alternatively, if the ue-Identity included in the Paging Records matches the terminal device identity allocated by upper layers, the terminal device may forward the ue-Identity to upper layers and accessType (if present) to the upper layers and perform the actions upon going to RRC IDLE.

However, according to conventional technologies, when the terminal device is in the center of the cell, it should work in the measurement relaxation mode. But then the terminal device moves from the center to the edge of the cell, the terminal device may exit the measurement relaxation mode. But after T_{searchdeltaP}, the terminal device may set the S_{rxlevref} to the new Sᵣₓₗₑᵥ And then, after T_{searchdeltaP} period of time, the terminal device shall perform measurement relaxation again. But if the terminal device is in cell edge, the terminal device will not perform measurement until it enters another cell.

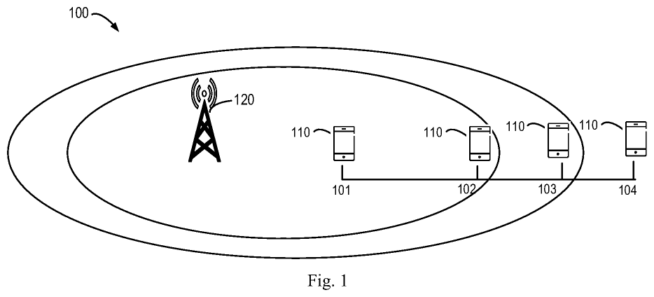

For example, as shown in FIG. 1, at time 101, the terminal device 110 may be in the center of the cell of the network device 120, the terminal device 110 may update the S_{rxlevref} to the current Sᵣₓₗₑᵥ and will not perform measurement due to measurement relaxation. At time 102, the terminal device 110 may move towards the border of the cell, then it will begin performing measurement since the relaxed measurement condition is not fulfilled. At time 103, the terminal device 110 may keep moving to the edge of the cell. Since the time between the time 102 and the time 103 is over T_{searchdeltaP}, the terminal device 110 may update the S_{rxlevref} by the current Sᵣₓₗₑᵥ and not perform measurement. At time 104, the terminal device 110 may keep moving out of the cell. The terminal device 110 may still not perform measurement, even it moves out of the cell, which may cause problems.

Moreover, when the stationary/low mobility terminal device moves to the other side of the cell which is far away to a cell with high priority frequency, the terminal device may still perform measurement to this high priority frequency. This may introduce a mechanism to disable the terminal device to perform measurement to that high priority frequency, in order to realize power saving.

Further, in the conventional paging mechanism, paging is a RRC message, which includes identities of terminal devices. If the ue-Identity included in the paging record matches the identity of the terminal device allocated by upper layers, the terminal device should consider itself in the paging list, and then forward the ue-Identity to the upper layers. If the ue-Identity is not included in the paging record matches the identity of the terminal device allocated by upper layers, the terminal device may discard the TB. However, the terminal device has to monitor the PO and waste resources to descramble the information.

In order to solve at least part of the aforementioned problems, new technologies in a relaxation measurement enhancement are needed. According to embodiments of the present disclosure, new power thresholds are introduced for triggering and/or quitting the relaxed measurement mode. In this way, the terminal device can be avoided entering into the relaxed measurement mode if the terminal device is at the cell edge. Further, a network device configured mapping information of neighbor cells for entering the relaxed measurement mode. In this way, the related measurement mode can be selected for a proper neighboring cell. Moreover, a terminal device may be configured with one or more identities for descrambling downlink information. In this way, resources at the terminal device can be saved.

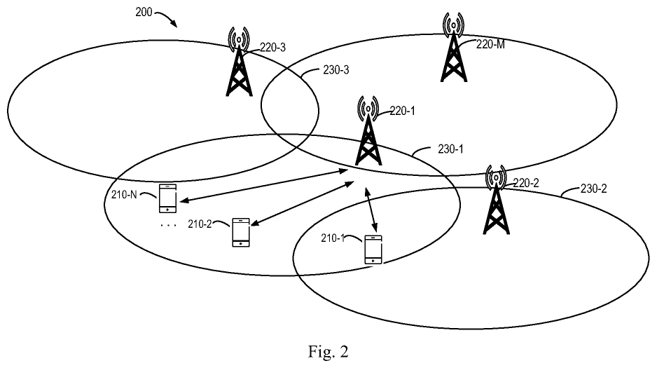

FIG. 2 illustrates a schematic diagram of a communication system in which embodiments of the present disclosure can be implemented. The communication system 200, which is a part of a communication network, comprises a terminal device 210-1, a terminal device 210-2, . . . , a terminal device 210-N, which can be collectively referred to as “terminal device(s) 210.” The number N can be any suitable integer number.

The communication system 200 further comprises a network device 220-1, a network device 220-2, . . . , a network device 220-M, which can be collectively referred to as “network device(s) 220.” The number M can be any suitable integer number. In the communication system 200, the network devices 210 and the terminal devices 220 can communicate data and control information to each other. The numbers of terminal devices and network devices shown in FIG. 2 are given for the purpose of illustration without suggesting any limitations.

Communications in the communication system 200 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

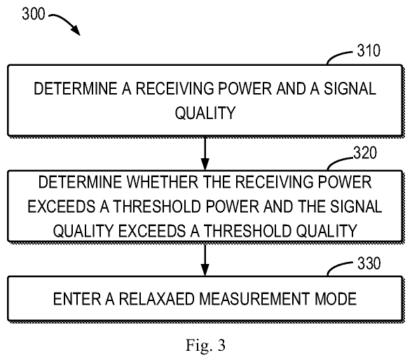

Embodiments of the present disclosure will be described in detail below. Reference is first made to FIG. 3, which shows a flowchart of an example method 300 in accordance with an embodiment of the present disclosure. Only for the purpose of discussion, the method 300 will be described with reference to FIG. 2. The method 300 may be implemented at the terminal device 210-1 in FIG. 2.

At block 310, the terminal device 210-1 determines a receiving power of a signal transmitted on a serving cell 230-1. The terminal device 210-1 also determines a signal quality of the signal transmitted on between the terminal device 210-1 and a network device 220-1 in the serving cell 230-1. For example, the terminal device 210-1 may obtain a reference signal receiving power. In addition, the terminal device 210-1 may also obtain a reference signal receiving quality.

In some embodiments, the terminal device 210-1 may determine whether the condition for entering the relaxed measurement mode is satisfied. The condition may be pre-determined at the terminal device 210-1. Alternatively, information regarding the condition may be received from other devices, for example, the network devices. The term “relaxed measurement mode” may refer to a mode where the terminal device performs less number of measurements than a normal measurement mode. For example, the criterion for the relaxed measurement mode is as below:

S_{rxlevRef}−Sᵣₓₗₑᵥ<SSearchDeltaP (2)

where Sᵣₓₗₑᵥ presents current Sᵣₓₗₑᵥ value of the serving cell (dB), S_{rxlevRef} represents reference Sᵣₓₗₑᵥ value of the serving cell (dB).

At block 320, the terminal device 210-1 determines whether the receiving power (for example, represented as Sᵣₓₗₑᵥ) exceeds the threshold power (for example, represented as S_{intrasearchP}) and the signal quality (for example, represented as S_{qual}) exceeds a threshold quality (for example, represented as S_{intrasearch}). In some embodiments, the terminal device 210-1 may be enforced not to update the S_{rxlevref} when the Sᵣₓₗₑᵥ is smaller S_{intrasearchP} and S_{qual} is smaller S_{intrasearch}. In some embodiments, the threshold power is a reference signal receiving power threshold for activating an intra-frequency measurement and the threshold quality is a reference signal receiving quality threshold for activating an intra-frequency measurement.

At block 330, the terminal device 210-1 enters the relaxed measurement mode on the serving cell 230-1 if the received power exceeds the threshold power and the signal quality exceeds the threshold quality. In some embodiments, if the receiving power decreases to a value which is larger than a configured power (S_{rxlevrefconf}) but lower than a further reference power (S_{rxlevref}), the terminal device 210-1 may update the further reference power to be the receiving power. For example, if the relaxed monitoring criterion has not been met for T_{SearchDeltaP} and the Sᵣₓₗₑᵥ exceeds S_{intrasearchP} and S_{qual} exceeds S_{intrasearchQ}, the terminal device 210-1 shall set the value of S_{rxlevRef} to the current Sᵣₓₗₑᵥ value of the serving cell, which means that the terminal device 210-1 enters the relaxed measurement mode. In some embodiments, T_{SearchDeltaP} may be 5 minutes, or the e-discontinuous reception (drx) cycle length if eDRX is configured and the eDRX cycle length is longer than 5 minutes.

Alternatively, the further reference power (S_{rxlevref}) is the latest value of a certain period of Tᵣₓₗₑᵥ. Tᵣₓₗₑᵥ is a timer which is configured by the network device 220-1 (for example, via system information of dedicated RRC configuration). When the terminal device 210-1 updates the S_{rxlevref} by the higher Sᵣₓₗₑᵥ, it may start timer Tᵣₓₗₑᵥ. When the timer expires, the terminal device 210-1 may update the S_{rxlevref} with the latest measured receiving power (Sᵣₓₗₑᵥ) value. In other embodiments, the the terminal device 210-1 may update the further reference power (S_{rxlevref}) by an average value of measured receiving power values when the timer Tᵣₓₗₑᵥ is running.

In some embodiments, a reference power (for example, represented as S_{rxlevRefQ}) may be introduced to quite the relaxed measurement mode. In some embodiments, the S_{rxlevRefQ} may be higher than S_{intrasearchP}, namely, the reference power may be higher than the threshold power. For example, the terminal device 210-1 may determine a further receiving power of a further signal on the serving cell 230-1. If the further receiving power is smaller than the further reference power, the terminal device 210-1 may leave the relaxed measurement mode. For example, the terminal device 210-1 may enter the normal measurement mode.

Alternatively, the terminal device 210-1 may determine a further receiving power of a further signal transmitted on the serving cell 230-1. The terminal device 210-1 may also determining a further signal quality of the further signal transmitted on the serving cell 230-1. If the further receiving power is below the threshold power and the further signal quality is below the threshold quality, the terminal device 210-1 may leave the relaxed measurement mode. For example, the terminal device 210-1 may enter the normal measurement mode.

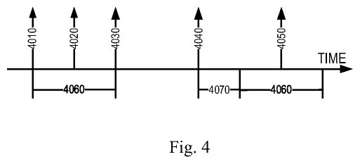

In some embodiments, as shown in FIG. 4, the terminal device 210-1 may perform measurement at time 4020 during a measuring period 4060 between the time 4010 and the time 4030. The terminal device 210-1 may enter the relaxed measurement mode at the time 4030 and leave the relaxed measurement mode at time 4040. The terminal device 210-1 may run a first timer (for example, represented as “T_{quit}”) from the time 4040. The terminal device 210-1 may not re-enter the relaxed measurement mode during the timer period (shown as the time period 4070 in FIG. 4). A second timer (for example, represented as “T_{searchdeltaP}”) may be started after an expiration of the first timer. For example, as shown in FIG. 4, the new measuring period 4060 may be started after the time period 4070. The terminal device 210-1 may perform measurement at the time 4050 during the new measuring period 4060.

According to embodiments of the present disclosure, the terminal device can be avoided entering into the relaxed measurement mode when the signal quality is relatively bad. In this way, even though the terminal device may be in relaxed measurement mode previously, the terminal device can perform measurement if it moves out of the serving cell. Further, it avoids frequently switching between the normal measurement mode and the relaxed measurement

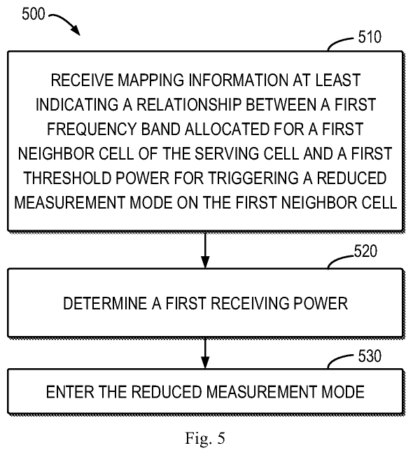

FIG. 5 shows a flowchart of an example method 500 in accordance with an embodiment of the present disclosure. Only for the purpose of illustrations, the method 500 can be implemented at a terminal device 210-1 as shown in FIG. 2.

In some embodiments, if the frequencies of neighbor cells (for example, cells 230-2 and 230-3) have a higher priority than the serving frequency, when the serving cell doesn't fulfills the criteria, then the terminal device shall keep performing the measurement of neighbor cells. Then for low mobility terminal device, especially for a stationary terminal device, when it is located at the other side (for example, closer to the cell 230-2) of the serving cell, it should be able to disable the measurement of the frequency of cell 230-3.

At block 510, the terminal device 210-1 receives mapping information transmitted on a serving cell 230-1 from a network device 220-1. The mapping information at least indicates a relationship between a first frequency band allocated for a first neighbor cell (for example, the cell 230-3) of the serving cell and a first threshold power for triggering a reduced measurement mode on the first neighbor cell. The term “reduced measurement mode” may refer to a mode where the terminal device performs reduced number of measurements than a normal measurement mode. Table 1 and Table 2 show examples of mapping information, respectively. It should be noted that parameters shown in Table 1 and Table 2 are only examples not limitations.

TABLE 1

| | Reference | | | |
|---|---|---|---|---|
| | Frequency | Threshold | Frequency | Threshold |
| Entry 1 | F1 | x dB | F3 | a dB |
| Entryv2 | F2 | y dB | F4 | b dB |

TABLE 2

| | Reference | | | |
|---|---|---|---|---|
| | Frequency | Tsearchdelta | Frequency | Trexactive |
| Entry 1 | F3 | c min | x dB | e hours |
| Entry 2 | F4 | d min | y dB | f hors |

At block 520, the terminal device 210-1 determines a first receiving power of a first signal transmitted at the first frequency band. For example, the terminal device may determine the RSRP of the first neighbor cell 230-3.

At block 530, the terminal device 210-1 enters the reduced measurement mode on the first neighbor cell based on the receiving power and the mapping information. For example, as shown in Table 1, in entry 1, for F1, if the first receiving power is higher than the x dB of the neighbor cell 230-2 and is lower than a dB of the neighbor cell 230-3, it means that the terminal device 210-1 is closer to the neighbor cell 230-2. Generally, the value x dB is larger than the value a dB. In this situation, the terminal device 210-1 may enter the reduced measurement mode in the neighbor cell 230-3.

In some embodiment, as shown in Table 2, the mapping information may only comprise the threshold of the first neighbor cell (for example, the cell 230-3) of which signals are fading to the terminal device 210-1. If the first receiving power is lower x dB and the first receiving power keeps lower than x dB for the period of c min (T_{searchdelta}), the terminal device 210-1 may enter the reduced measurement mode in the neighbor cell 230-3.

In some embodiments, if the terminal device 210-1 has entered the reduced measurement mode for the cell 230-3, the terminal device 210-1 may start a timer (for example, T_{rexactive}). Before an expiration of the timer, the terminal device 210-1 may suspend the power measurement on the cell 230-3 unless one of the following is satisfied: a reselection of a neighbor cell; a radio resource control status changed to be a radio resource control connected status, or a third receiving power of the serving cell being lower than a third threshold level. More specifically, during the timer T_{rexactive} is running, the terminal device 210-1 will not perform measurement on the cell 230-3, only if: the terminal device 210-1 performs at least cell reselection once, the terminal device 210-1 changes the status to RRC Connected, or the serving cell 230-2's receiving power is lower than a configured threshold−Sservthd.

After the expiration of the timer, the terminal device 210-1 may quit/leave the reduced measurement mode and start to perform the measurement to higher priority frequencies, for example, F3. In some embodiments, the terminal device 210-1 may reenter the reduced measurement mode if the condition of reduced measurement mode fulfills.

According to embodiments of the present disclosure, the terminal device is able to select the proper cell to perform reduced measurement mode. In this way, the measurement keeps efficient while less resources are used. The power at the terminal device can also be saved.

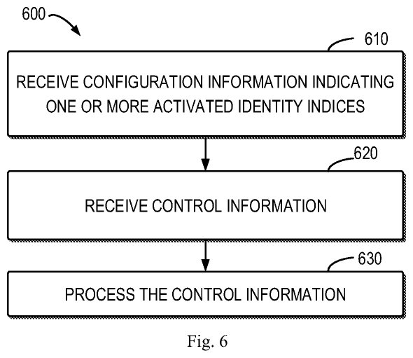

FIG. 6 shows a flowchart of an example method 600 in accordance with an embodiment of the present disclosure. Only for the purpose of illustrations, the method 600 can be implemented at a terminal device 210-1 as shown in FIG. 2.

At block 610, the terminal device 210-1 receives configuration information from the network device 220-1. The configuration information indicates one or more activate identity indices for paging. For example, if a power of the terminal device 210-1 is below a threshold power, in other words, the terminal device 210-1 is a lower power terminal device, the terminal device 210-1 may be only configured with one activate identity index. In some embodiments, the network device 220-1 may configure a paging radio network temporary identifier (P-RNTI). Alternatively, the terminal device 210-1 may be configured with a P-RNTI index. In some embodiments, the configuration information may be transmitted in medium access control (MAC) control element (CE). Alternatively, the RRC Release message may comprise the configuration information.

In some embodiments, the terminal device 210-1 may receive pre-configuration information from the network device 220-1. The pre-configuration information indicates a plurality of identity indices for the paging which can be configured to the terminal device 210-1. The one or more activate identity indices may be included in the plurality of identity indices. The plurality of identity indices may comprise any suitable numbers of identity indices, for example, 4, 8, and 16. For example, the terminal device 210-1 may be configured with 4 P-RNTI indices, with each active identity index in the same time. Table 3 below shows the plurality of identity indices.

TABLE 3

| P-RNTI | IDEX |
|---|---|
| FFFA | P-RNTI Index 1 |
| FFFB | P-RNTI Index 2 |
| FFFC | P-RNTI Index 3 |
| FFFD | P-RNTI Index 4 |

At block 620, the terminal device 210-1 receives control information from the network device 220-1. In some embodiments, the control information may be scrambled with the activated P-RNTI index. For example, if the P-RNTI index 2 is activated, the control information may be scrambled with the P-RNTI index 2. In some embodiments, the terminal device 210-1 may monitor the PO to obtain the control information.

At block 630, the terminal device 210-1 processes the control information based on the one or more activate identity indices. For example, if the activated indices are P-RNTI index 2 and P-RNTI index 4, the terminal device 210-1 may descramble the control information with the P-RNTI index 2 and the P-RNTI index 4. If the control information can be successfully descrambled with one of the activated identity indices, the descrambled control information may be delivered to upper layer (for example, RRC layer) for further processing. If the control information cannot be scrambled with the activated identity indices, the terminal device 210-1 may discard the control information. In this way, the terminal device 210-1 does not need to use more resources to process the control information, thereby saving resources.

In some embodiments, the terminal device 210-1 may obtain a list of identity indices from the control information. The terminal device 210-1 may determine whether the one or more activated identity indices are included in the list of identity indices. If the configured one or more activated identity indices (for example, the P-RNTI index 2 and the P-RNTI index 4) are in the list of identity indices, the control information may be delivered to upper layer (for example, RRC layer) for further processing. In the list does not comprise the configured one or more activated identity indices, the terminal device 210-1 may discard the control information. In this way, the terminal device 210-1 does not need to use more resources to process the control information, thereby saving resources.

According to embodiments of the present disclosure, the terminal device is able to determine whether the control information is associated with the terminal device at the physical layer. The terminal device does not need to the deliver the control information to upper layer if the control information is not scrambled with activated identity index or does not comprise the activated identity index. In this way, resources at the terminal device can be saved.

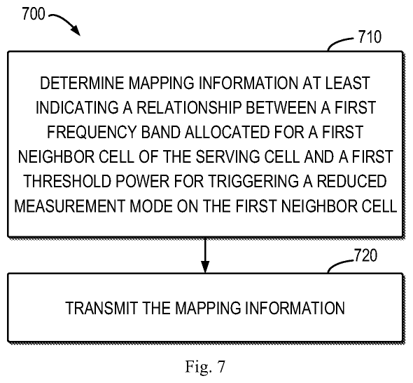

FIG. 7 shows a flowchart of an example method 700 in accordance with an embodiment of the present disclosure. Only for the purpose of illustrations, the method 700 can be implemented at a network device 220-1 as shown in FIG. 2.

At block 710, the network device 220-1 determines mapping information. The mapping information at least indicates a relationship between a first frequency band allocated for a first neighbor cell (for example, the cell 230-3) of the serving cell and a first threshold power for triggering a reduced measurement mode on the first neighbor cell. The term “reduced measurement mode” may refer to a mode where the terminal device performs reduced number of measurements than a normal measurement mode.

In some embodiments, the mapping information further indicates a second frequency band allocated for a second neighbor cell and a second threshold power. In other embodiments, the mapping information further indicates a threshold period time for triggering the reduced measurement mode.

At block 720, the network device 220-1 transmits the mapping information to the terminal device 210-1.

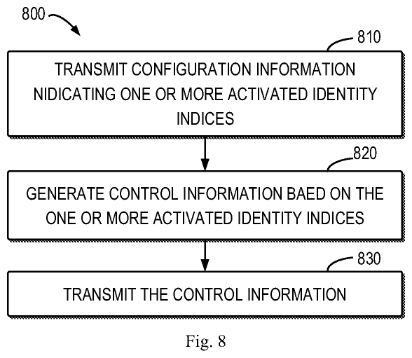

FIG. 8 shows a flowchart of an example method 800 in accordance with an embodiment of the present disclosure. Only for the purpose of illustrations, the method 800 can be implemented at a network device 220-1 as shown in FIG. 2.

At block 810, the network device 210-1 transmits configuration information to the terminal device 210-1. The configuration information indicates one or more activate identity indices for paging. For example, if a power of the terminal device 210-1 is below a threshold power, in other words, the terminal device 210-1 is a lower power terminal device, the network device 210-1 may only configure with one activate identity index to the terminal device 210-1.

In some embodiments, the network device 220-1 may configure a paging radio network temporary identifier (P-RNTI). Alternatively, the terminal device 210-1 may be configured with a P-RNTI index. In some embodiments, the configuration information may be transmitted in medium access control (MAC) control element (CE). Alternatively, the RRC Release message may comprise the configuration information.

In some embodiments, the network device 220-1 may transmit pre-configuration information to the terminal device 210-1. The pre-configuration information indicates a plurality of identity indices for the paging which can be configured to the terminal device 210-1. The one or more activate identity indices may be included in the plurality of identity indices. The plurality of identity indices may comprise any suitable numbers of identity indices, for example, 4, 8, and 16. For example, the terminal device 210-1 may be configured with 4 P-RNTI indices, with each active identity index in the same time.

At block 820, the network device 220-2 generates control information based on the one or more activate identity indices for paging. In some embodiments, the control information may be scrambled with the one or more activate identity indices. Alternatively, the control information may comprise a list of identity indices for paging.

At block 830, the network device 220-2 transmits the control information to the terminal device 210-1.

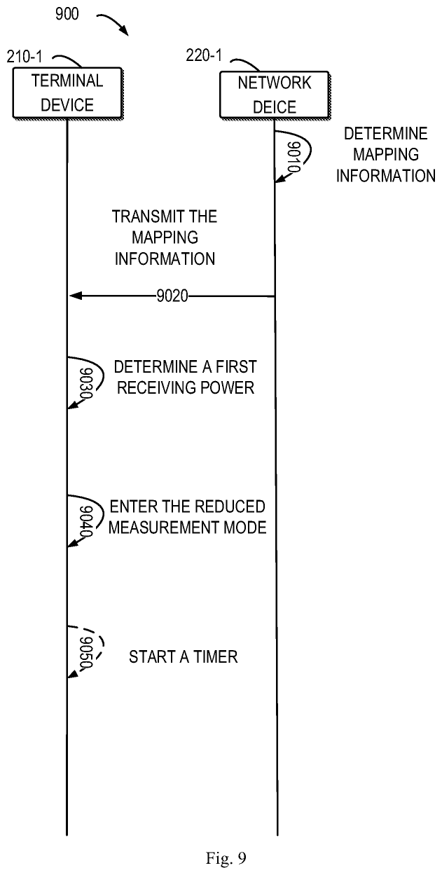

Reference is now made to FIG. 9, which illustrates a signaling flow for relaxed measurements according to some example embodiments of the present disclosure. For the purpose of discussion, the process 900 will be described with reference to FIG. 2. The signaling flow 900 may involve the terminal device 210-1 and the network device 220-1.

The network device 220-1 determines 9010 mapping information. The mapping information at least indicates a relationship between a first frequency band allocated for a first neighbor cell (for example, the cell 230-3) of the serving cell and a first threshold power for triggering a reduced measurement mode on the first neighbor cell. The term “reduced measurement mode” may refer to a mode where the terminal device performs reduced number of measurements than a normal measurement mode.

In some embodiments, the mapping information further indicates a second frequency band allocated for a second neighbor cell and a second threshold power. In other embodiments, he mapping information further indicates a threshold period time for triggering the reduced measurement mode.

The network device 220-1 transmits 9020 the mapping information to the terminal device 210-1. The terminal device 210-1 determines 9030 a first receiving power of a first signal transmitted at the first frequency band. For example, the terminal device may determine the RSRP of the first neighbor cell 230-3.

The terminal device 210-1 enters 9040 the reduced measurement mode on the first neighbor cell based on the receiving power and the mapping information. For example, as shown in Table 1, in entry 1, for F1, if the first receiving power is higher than the x dB of the neighbor cell 230-2 and is lower than a dB of the neighbor cell 230-3, it means that the terminal device 210-1 is closer to the neighbor cell 230-2. Generally, the value x dB is larger than the value a dB. In this situation, the terminal device 210-1 may enter the reduced measurement mode in the neighbor cell 230-3.

In some embodiment, as shown in Table 2, the mapping information may only comprise the threshold of the first neighbor cell (for example, the cell 230-3) of which signals are fading to the terminal device 210-1. If the first receiving power is lower x dB and the first receiving power keeps lower than x dB for the period of c min (T_{searchdelta}), the terminal device 210-1 may enter the reduced measurement mode in the neighbor cell 230-3.

In some embodiments, if the terminal device 210-1 has entered the reduced measurement mode for the cell 230-3, the terminal device 210-1 may start 9050 a timer (for example, T_{rexactive}). Before an expiration of the timer, the terminal device 210-1 may suspend the power measurement on the cell 230-3 unless one of the following is satisfied: a reselection of a neighbor cell; a radio resource control status changed to be a radio resource control connected status, or a third receiving power of the serving cell being lower than a third threshold level. More specifically, during the timer T_{rexactive} is running, the terminal device 210-1 will not perform measurement on the cell 230-3, only if: the terminal device 210-1 performs at least cell reselection once, the terminal device 210-1 changes the status to RRC Connected, or the serving cell 230-2's receiving power is lower than a configured threshold−Sservthd.

After the expiration of the timer, the terminal device 210-1 may quit/leave the reduced measurement mode and start to perform the measurement to higher priority frequencies, for example, F3. In some embodiments, the terminal device 210-1 may reenter the reduced measurement mode if the condition of reduced measurement mode fulfills.

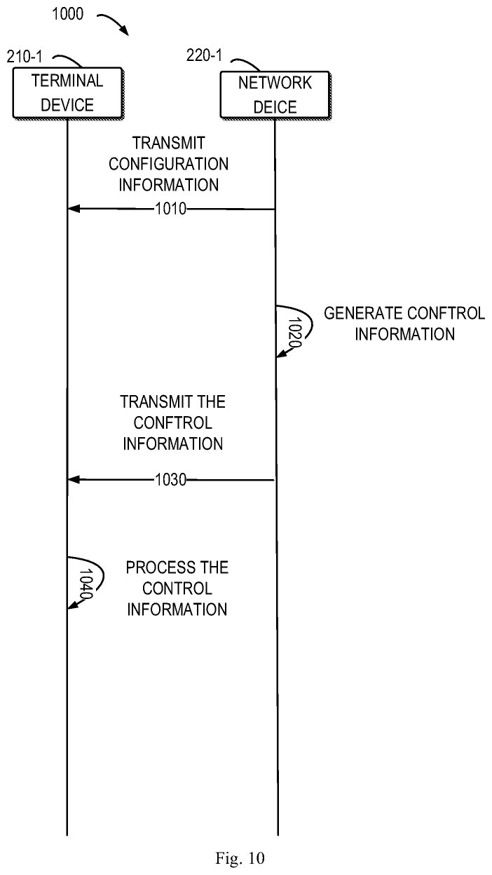

FIG. 10 illustrates a signaling flow for paging according to some example embodiments of the present disclosure. For the purpose of discussion, the process 1000 will be described with reference to FIG. 2. The signaling flow 1000 may involve the terminal device 210-1 and the network device 220-1.

The network device 210-1 transmits 1010 configuration information to the terminal device 210-1. The configuration information indicates one or more activate identity indices for paging. For example, if a power of the terminal device 210-1 is below a threshold power, in other words, the terminal device 210-1 is a lower power terminal device, the network device 210-1 may only configure with one activate identity index to the terminal device 210-1.

In some embodiments, the network device 220-1 may configure a paging radio network temporary identifier (P-RNTI). Alternatively, the terminal device 210-1 may be configured with a P-RNTI index. In some embodiments, the configuration information may be transmitted in medium access control (MAC) control element (CE). Alternatively, the RRC Release message may comprise the configuration information.

In some embodiments, the network device 220-1 may transmit pre-configuration information to the terminal device 210-1. The pre-configuration information indicates a plurality of identity indices for the paging which can be configured to the terminal device 210-1. The one or more activate identity indices may be included in the plurality of identity indices. The plurality of identity indices may comprise any suitable numbers of identity indices, for example, 4, 8, and 16. For example, the terminal device 210-1 may be configured with 4 P-RNTI indices, with each active identity index in the same time.

The he network device 220-2 generates 1020 control information based on the one or more activate identity indices for paging. In some embodiments, the control information may be scrambled with the one or more activate identity indices. Alternatively, the control information may comprise a list of identity indices for paging.

The network device 220-2 transmits 1030 the control information to the terminal device 210-1. The terminal device 210-1 processes 1040 the control information based on the one or more activate identity indices. For example, if the activated indices are P-RNTI index 2 and P-RNTI index 4, the terminal device 210-1 may descramble the control information with the P-RNTI index 2 and the P-RNTI index 4. If the control information can be successfully descrambled with one of the activated identity indices, the descrambled control information may be delivered to upper layer (for example, RRC layer) for further processing. If the control information cannot be scrambled with the activated identity indices, the terminal device 210-1 may discard the control information. In this way, the terminal device 210-1 does not need to use more resources to process the control information, thereby saving resources.

In some embodiments, the terminal device 210-1 may obtain a list of identity indices from the control information. The terminal device 210-1 may determine whether the one or more activated identity indices are included in the list of identity indices. If the configured one or more activated identity indices (for example, the P-RNTI index 2 and the P-RNTI index 4) are in the list of identity indices, the control information may be delivered to upper layer (for example, RRC layer) for further processing. In the list does not comprise the configured one or more activated identity indices, the terminal device 210-1 may discard the control information. In this way, the terminal device 210-1 does not need to use more resources to process the control information, thereby saving resources.

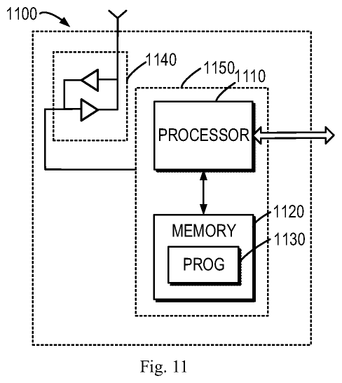

FIG. 11 is a simplified block diagram of a device 1100 that is suitable for implementing embodiments of the present disclosure. The device 1100 can be considered as a further example implementation of the terminal device 210 and the network device 220 as shown in FIG. 2. Accordingly, the device 1100 can be implemented at or as at least a part of the terminal device 210 or the network device 220.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 51140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 3 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method comprising:
determining, at a terminal device, a receiving power and a signal quality of a signal transmitted on a serving cell from a network device;
determining whether the receiving power exceeds a threshold power and the signal quality exceeds a threshold quality; and
in accordance with a determination that the receiving power exceeds the threshold power and the signal quality exceeds the threshold quality, entering a relaxed measurement mode with less number of measurements on the serving cell than a normal measurement mode.

2. The method of claim 1, further comprising:
determining a further receiving power of a further signal transmitted on the serving cell; and
in response to the further receiving power being below a reference power, entering the normal measurement mode, the reference power being higher than the threshold power.

3. The method of claim 1, further comprising:
determining a further receiving power of a further signal transmitted on the serving cell;
determining a further signal quality of the further signal transmitted on the serving cell; and
in response to the further receiving power being below the threshold power and the further signal quality being below the threshold quality, entering the normal measurement mode.

4. The method of claim 2 or 3, further comprising:
running a first timer after leaving the measurement relaxation mode; and
running a second timer after an expiration of the first timer.

5. The method of claim 1, wherein the threshold power is a reference signal receiving power threshold for activating an intra-frequency measurement and the threshold quality is a reference signal receiving quality threshold for activating an intra-frequency measurement.

6. The method of claim 1, further comprising:
in accordance with a determination that the receiving power is below the threshold power and the signal quality is below the threshold quality, suspending updating a further reference power to be the receiving power, the further reference power associated with the relaxed measurement mode.

7. A communication method comprising:
receiving, at a terminal device, mapping information transmitted on a serving cell from a network device, the mapping information at least indicating a relationship between a first frequency band allocated for a first neighbor cell of the serving cell and a first threshold power for triggering a reduced measurement mode on the first neighbor cell, the reduced measurement mode with reduced number of measurements than a normal measurement mode;
determining a first receiving power of a first signal transmitted at the first frequency band; and
entering the reduced measurement mode on the first neighbor cell based on the receiving power and the mapping information.

8. The method of claim 7, wherein the mapping information further indicates a second frequency band allocated for a second neighbor cell and a second threshold power, and wherein entering the reduced measurement mode comprises:
determining a second receiving power of a second signal transmitted at the second frequency band; and
in response to the first receiving power being below the first threshold power and the second receiving power exceeding the second threshold power, entering the reduced measurement mode on the first neighbor cell.

9. The method of claim 7, wherein the mapping information further indicates a threshold period time for triggering the reduced measurement mode, wherein entering the reduced measurement mode comprises:
comparing the first receiving power with the first threshold power; and
in response to the first receiving power being below the first threshold power during the threshold period of time, entering the reduced measurement mode on the first neighbor cell.

10. The method of claim 7, further comprising:
running a timer; and
suspending power measurement on the first neighbor cell before an expiration of the timer unless one of the following is satisfied:
a reselection of a neighbor cell,
a radio resource control status changed to be a radio resource control connected status, or
a third receiving power of the serving cell being lower than a third threshold level.

11. The method of claim 10, further comprising:
leaving the reduced measurement mode after an expiration of the timer; and
performing a normal measurement on the first neighbor cell.

12. A communication method comprising:
receiving, at a terminal device and from a network device, configuration information indicating one or more activated identity indices for paging;
receiving control information from the network device; and
processing the control information based on the one or more activated identity indices.

13. The method of claim 12, wherein processing the control information comprises:
descrambling the control information with the one or more activated identity indices;
in response to failing to descramble the control information, discarding the control information; or
in response to successfully descrambling the control information, processing the descrambled control information at a radio resource control layer of the terminal device.

14. The method of claim 12, further comprising:
receiving from a network device pre-configuration information indicating a plurality of identity indices for paging, the plurality of identity indices comprising the one or more activated identity indices.

15. The method of claim 12, wherein processing the control information comprises:
obtaining a list of identity indices for paging from the control information;
determining whether the list of identity indices includes the one or more activated identity indices;
in accordance with a determination that the list of identities indices excludes the one or more activate identity indices, discarding the control information; or
in accordance with a determination that the list of identities indices includes one or more activate identity indices, processing the descrambled control information at radio resource layer of the terminal device.

16. The method of claim 12, wherein the configuration information indicates a single activate identity index if a power level at the terminal device is below a threshold power level.

17. A communication method comprising:
determining, at a network device in a serving cell, mapping information at least indicating a relationship between a first frequency band allocated for a first neighbor cell of the serving cell and a first threshold power for triggering a reduced measurement mode on the first neighbor cell, the reduced measurement mode with reduced number of measurements than a normal measurement mode; and
transmitting the mapping information to at a terminal device in the serving cell.

18. The method of claim 17, wherein the mapping information further indicates a second frequency band allocated for a second neighbor cell and a second threshold power.

19. The method of claim 17, wherein the mapping information further indicates a threshold period time for triggering the reduced measurement mode.

20. A communication method comprising:
transmitting, at a network device, configuration information to a terminal device, the configuration information indicating one or more activated identity indices for paging;
generating control information based on the one or more activated identity indices; and
transmitting the control information to the network device.

21. The method of claim 20, wherein generating the control information comprises:
scrambling the control information with the one or more activated identity indices.

22. The method of claim 20, further comprising:
transmitting to the terminal device pre-configuration information indicating a plurality of identity indices for paging, the plurality of identity indices comprising the one or more activated identity indices.

23. The method of claim 20, wherein generating the control information comprises:
generating the control information indicating a list of identity indices for paging.

24. The method of claim 20, wherein a power level at the terminal device is below a threshold power level, and wherein transmitting the control information comprises:
transmitting the configuration information indicates a single activate identity index.

25. A terminal device, comprising:
a processing unit; and
a memory coupled to the processing unit and storing instructions thereon, the instructions, when executed by the processing unit, causing the terminal device to perform any one of claims 1-6.

26. A terminal device, comprising:
a processing unit; and
a memory coupled to the processing unit and storing instructions thereon, the instructions, when executed by the processing unit, causing the terminal device to perform any one of claims 7-11.

27. A terminal device, comprising:
a processing unit; and
a memory coupled to the processing unit and storing instructions thereon, the instructions, when executed by the processing unit, causing the terminal device to perform any one of claims 12-16.

28. A network device, comprising:
a processing unit; and
a memory coupled to the processing unit and storing instructions thereon, the instructions, when executed by the processing unit, causing the network device to perform any one of claims 17-19.

29. A network device, comprising:
a processing unit; and
a memory coupled to the processing unit and storing instructions thereon, the instructions, when executed by the processing unit, causing the network device to perform any one of claims 20-24.

30. A computer readable medium having instructions stored thereon, the instructions, when executed on at least one processor, causing the at least one processor to carry out the method according to any one of claims 1-16.

31. A computer readable medium having instructions stored thereon, the instructions, when executed on at least one processor, causing the at least one processor to carry out the method according to any one of claims 17-24.
